(19) United States
(12) Patent Application Publication
(10) Pub. No.: US 2004/0195453 A1
(43) Pub. Date: Oct. 7, 2004

(54) Method of securing composite elements together

(76) Inventor: John M Gaitonde, Filton (GB)

Correspondence Address: NIXON & VANDERHYE, PC, 1100 N GLEBE ROAD, 8TH FLOOR, ARLINGTON, VA, 22201-4714, US

(21) Appl. No.: 10/484,383

(22) PCT Filed: Jul. 11, 2002
(86) PCT No.: PCT/GB02/03187

(30) Foreign Application Priority Data
Jul. 21, 2001 (GB) 0117805.2

(51) Int. Cl. B64C 1/00

(52) U.S. Cl. 244/119

(57) ABSTRACT

A method is provided of forming a wing form composite components, whereby the composite components (2 and 20) are attached together using self-tapping screws (23).

The present invention relates to a method of securing composite elements together. The method is particularly suitable for use during the manufacture and/or repair of aircraft.

Traditionally, the airframe of aircraft has tended to be constructed using metal panels secured to a metal frame. These components are then attached together using techniques such as riveting or bolting. The use of screws is particularly avoided as they are known to potentially lead to the formation of fatigue cracks in a structure.

With continuing advances in materials science, composite materials have become available which can be used for the formation of structural components of an aircraft. Composite components are produced by bonding multiple layers of fibrous mat together in order to build up a desired shape and/or structural element. The fibres in any given layer typically predominately extend along one direction. Consequently, the “directions” of adjacent layers may be staggered in order to tailor the structural properties of the composite material to those required by the designer.

Typically the formation of complex shapes has required the creation of a suitably shaped former over which the layers of fibrous material are placed, and impregnated with a resin, prior to curing. The formation of complex shapes can be labour intensive. Thus, although the components having a complex shape frequently meet the design criteria from an engineering point of view, the cost of production may make their use prohibitively expensive.

According to a first aspect of the present invention, there is provided a method of attaching first and second elements together during the manufacture or repair of an aircraft, wherein the elements are formed of composite material, the method comprising presenting a self-tapping screw to a surface of the first element and rotating the screw such that it passes through the first element and into the body of the second element so as to attach the first and second elements to one another.

It is thus possible to attach separate composite elements together using self-tapping screws. The use of screw fasteners in this way is against the commonly accepted technical practice in the aircraft industry since, as noted hereinabove, the use of screw fasteners is generally perceived to potentially lead to the formation of fatigue cracks within metal components. However, the applicant has realised that screw fasteners do not cause a fatigue problem in composite components. Furthermore, in preliminary tests the applicant has discovered that screw fasteners give surprisingly good shear and pull out performance when used with composite materials. This is thought to be because the screw tends to compress and trap portions of the fibrous layers between adjacent sections of the screw thread.

Preferably the screw is a self-tapping and self-drilling screw. A self-drilling screw effectively has a pilot drill integrally formed with the shaft of the screw. Thus the use of separate pilot drills to preform a pilot hole is avoided. The self-drilling and self-tapping screw can be presented to a composite element, and then screwed into the element, thereby cutting its own pilot hole.

Advantageously countersunk screws may be used such that they lie flush with the surface of the composite component through which they pass. Such screws may be used for attaching panels to supporting struts or spars in, for example, the formation of a wing. Indeed, suitably shaped and profiled panels may be attached together to form a box wing. The use of countersunk screws would be beneficial in areas where it is important to maintain a smooth aerodynamic surface. However, this requires a prior countersinking operation to be performed on the panel.

Where it is desired to join panels together, suitable linking elements, for example elongated bars having an “L” shaped cross-section may be constructed out of composite material these effectively form linking and strengthening brackets.

According to a second aspect of the present invention, there is provided an aircraft wing, said wing having a plurality of elements therein formed of composite material, wherein elements of composite material are fastened together via self-tapping screws.

The present invention will further be described, by way of example, with reference to the accompanying drawings, in which:

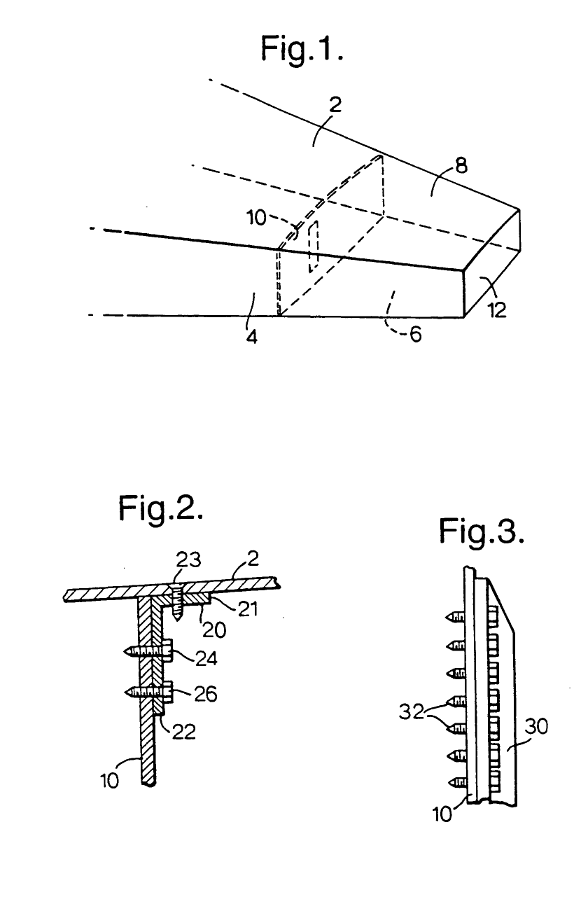

FIG. 1 is a simplified section through an aircraft wing having a box construction;

FIG. 2 illustrates how a wing panel is attached to a supporting rib; and

FIG. 3 schematically illustrates how two panels may be attached together to provide a section of increased structural rigidity.

FIG. 1 schematically illustrates a wing formed according to a box design. In this design, an upper panel 2, a forward panel 4, a lower panel 6, and a rear panel 8 co-operate to define a central box which serves to impart the basic shape to the wing, to give structural rigidity to the wing, and which also may serve to define walls of fuel tanks provided in the wing. In order to hold the walls 2, 4, 6 and 8 in position with respect to one another, ribs are periodically positioned throughout the length of the wing. In the example shown in FIG. 1, only two ribs 10 and 12 are shown for the sake of simplicity. These elements 10 and 12 effectively subdivide the wing into a series of contiguous boxes.

It is necessary to join the panels 2, 4, 6 and 8 to each other at their edges and also to the ribs 10 and 12. An effective way of doing this is schematically illustrated in FIG. 2. As shown in FIG. 2, the point of attachment between the upper panel 2 and the rib 10 is provided by an intermediate element 20 which defines a first flange 21 which, in use bears against the panel 2, attached to second flange 22, which in use bears against the rib 10. In order to connect the intermediate element 20 to the panel 2 and rib 10, self-drilling self-tapping screws are used. A first of these screws, 23, is countersunk in order that the head of the screw lies flush with the upper surface of the upper panel 2 as shown in FIG. 2. However, where it is not important for the screw head to be flush non-countersunk screws, such as screws having a bolt like head, may be used.

Self-drilling self-tapping screws are commercially available and are known to the person skilled in the art. Thus they need not be described more fully here.

The ribs 10 and 12 do not need to be of uniform thickness. It may, for example, be desirable for the ribs 10 and 12 to be effectively thicker near their edges and possibly have one or two regions of increased thickness at intermediate portions along the rib. Rather than form complex shapes, the rib profile can be built up by attaching strengthening elements 30 to the rib 10 using self-tapping screws 32 as shown in FIG. 3. This allows components having complex load bearing profiles to be constructed from easily formable planar elements.

1. A method of attaching first and second elements together during manufacture or repair of an aircraft, wherein the elements are formed of composite material, the method comprising presenting a self-tapping screw to a surface of the first element, and rotating the screw such that it passes through the first element and into the body of the second element so as to attach the first and second elements to one another.

2. A method as claimed in claim 1, in which the self-tapping screw is a self-drilling screw.

3. A method as claimed in claim 1, in which the self-tapping screw extends completely through the second element.

4. A method as claimed in claim 1 in which the first and second elements are formed of laminated elements, and the longitudinal axis of the self-tapping screw is perpendicular to the plane of the laminate.

5. A method as claimed in any one of the preceding claim 1, in which one of the first and second elements is a panel element and the other of the first and second elements is a strut.

6. A method as claimed in claim 5, in which the panel is part of the skin of an aircraft wing.

7. An aircraft wing, said wing having a plurality of elements therein formed of composite material, wherein elements of composite material are fastened to one another via self-tapping screws.
